(19) United States
(12) Patent Application Publication
(10) Pub. No.: US 2024/0059177 A1
(43) Pub. Date: Feb. 22, 2024

(54) VEHICLE BIDIRECTIONAL ENERGY TRANSFER MANAGEMENT METHODS AND SYSTEMS

(71) Applicant: Ford Global Technologies, LLC, Dearborn, MI (US)

(72) Inventors: Dominique Meroux, San Francisco, CA (US); Hossein Sartipizadeh, Canton, MI (US); Ryan J. O'Gorman, Beverly Hills, MI (US); Stuart C. Salter, White Lake, MI (US)

(21) Appl. No.: 17/892,266

(22) Filed: Aug. 22, 2022

(51) Int. Cl. B60L 55/00; B60L 53/00; H02J 3/32

(52) U.S. Cl. CPC B60L 55/00; B60L 53/00; H02J 3/322; H02J 2310/48; H02J 2310/12; H02J 2300/20; G06Q 30/0645

(57) ABSTRACT

A local electrical energy management method includes, when an grid power source is not providing electrical energy to an electrical load, receiving electrical energy from an electrified vehicle and powering the electrical load with the electrical energy from the electrified vehicle. The method further includes compensating a user of the electrified vehicle for providing electrical energy.

### TECHNICAL FIELD

This disclosure relates generally to methods for coordinating and achieving bidirectional energy transfers between vehicles and an electrical load, particularly an electrical load associated with a multi-unit dwelling.

### BACKGROUND

Electrified vehicles differ from conventional motor vehicles because they are selectively driven by one or more traction battery pack powered electric machines. The electric machines can propel the electrified vehicles instead of, or in combination with, an internal combustion engine. Plug-in type electrified vehicles include one or more charging interfaces for charging the traction battery pack. Plug-in type electrified vehicles are typically charged while parked at a charging station or some other utility power source. Charging electrified vehicles can become challenging, if possible at all, during electrical power outage conditions.

### SUMMARY

In some aspects, the techniques described herein relate to a local electrical energy management method, including: when an grid power source is not providing electrical energy to an electrical load, receiving electrical energy from an electrified vehicle and powering the electrical load with the electrical energy from the electrified vehicle; and compensating a user of the electrified vehicle for providing electrical energy.

In some aspects, the techniques described herein relate to a local management method, wherein the load is a load associated with a multi-unit dwelling.

In some aspects, the techniques described herein relate to a local management method, wherein the user is a resident of the multi-unit dwelling.

In some aspects, the techniques described herein relate to a local management method, wherein the multi-unit dwelling is an apartment complex, a condominium complex, or both.

In some aspects, the techniques described herein relate to a local management method, wherein the electrical load is an electrical load of the multi-unit dwelling.

In some aspects, the techniques described herein relate to a local management method, wherein the electrical load is electrically decoupled from the grid power source during the powering.

In some aspects, the techniques described herein relate to a local management method, further including compensating by providing a rent credit to the user.

In some aspects, the techniques described herein relate to a local management method, further including additionally compensating the user for storing backup electrical energy within electrified vehicle.

In some aspects, the techniques described herein relate to a local management method, wherein the compensating includes a non-monetary benefit for the user.

In some aspects, the techniques described herein relate to a local management method, wherein the compensating is varied based on an amount of electrical energy provided by the electrified vehicle.

In some aspects, the techniques described herein relate to a local management method, wherein the electrified vehicle is a first electrified user and the user is a first user, and further including, when an grid power source is not providing power to an electrical load, additionally powering the load using a second electrified vehicle, and compensating a second user of the second electrified vehicle for the powering.

In some aspects, the techniques described herein relate to a local management method, further including delivering electrical energy from the electrified vehicle to the electrical load through a bidirectional charger.

In some aspects, the techniques described herein relate to an electrical energy providing method, including: electrically coupling an electrified vehicle to a bidirectional charger. The through the bidirectional charger, powering an electrical load of a multi-unit dwelling from the electrified vehicle; and receiving compensation for the powering.

In some aspects, the techniques described herein relate to an electrical energy providing method, wherein the powering is during a grid outage when electrical energy from a grid power source is unavailable to power the electrical load.

In some aspects, the techniques described herein relate to an electrical energy providing method, wherein a user of the electrified vehicle receives the compensation, the user a resident of the multi-unit dwelling.

In some aspects, the techniques described herein relate to an electrical energy providing method, wherein the compensation includes a rent credit.

In some aspects, the techniques described herein relate to an electrical energy providing method, wherein the user is a first user, wherein the electrical load includes a load associated with a first unit of the multi-unit dwelling where the first user resides, and a load associated with a different, second unit of the multi-unit dwelling where a second user resides.

In some aspects, the techniques described herein relate to an electrical energy providing method, wherein the compensation receives is varied based on electrical energy provided.

In some aspects, the techniques described herein relate to an electrical energy compensating method, including: making an electrified vehicle available to provide power to a multi-unit dwelling through a bidirectional charger; and receiving compensation for making the electrified vehicle available to provide power to the multi-unit dwelling.

In some aspects, the techniques described herein relate to an electrical energy compensating method, further including making the electrified vehicle available by electrically coupling the electrified vehicle to the bidirectional charger.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a charging station, an electrified vehicle, a local renewable energy system, and an grid power source.

FIG. 2 illustrates a side and partially schematic view of the electrified vehicle of FIG. 2.

FIG. 3 illustrates a flow of an example local electrical energy management method

### DETAILED DESCRIPTION

A multi-unit dwelling is a classification of housing where multiple housing units are contained within a building or complex. Example multi-unit dwellings includes townhomes, apartment building, and duplexes. This disclosure, among other things, describes example methods of incentivizing residents of a multi-unit dwelling to use electrified vehicles to provide electrical energy to the multi-unit dwelling. Residents in multi-unit dwellings often lack access to at-home charging and innovative functionality like grid services and backup power that require bidirectional infrastructure.

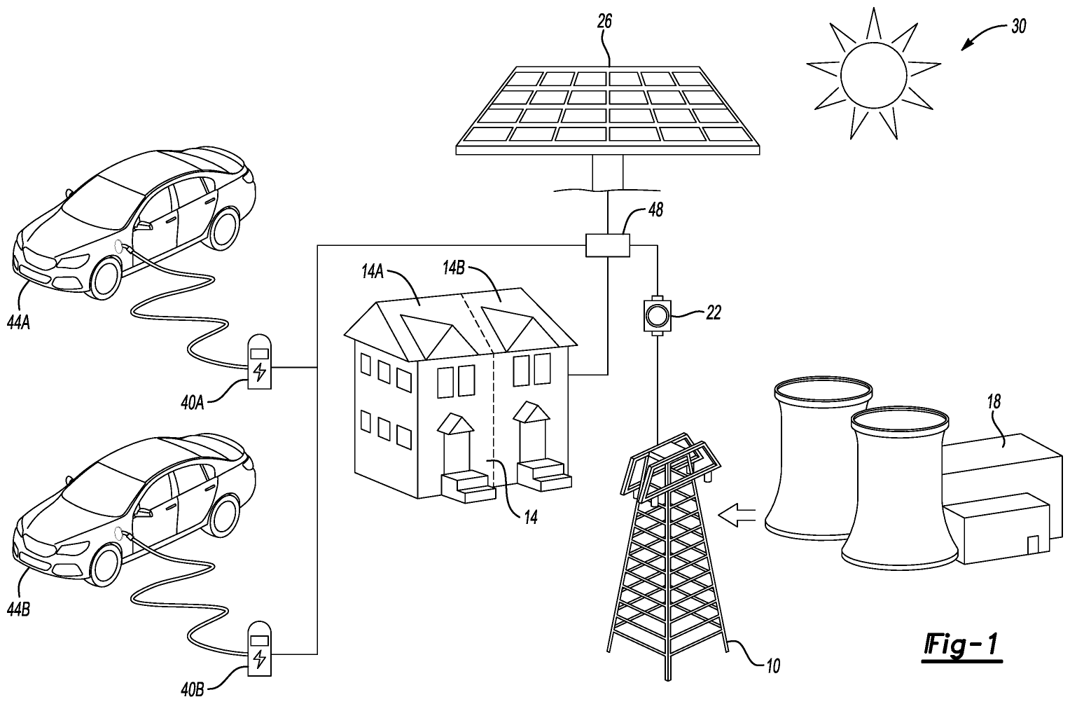

With reference to FIG. 1, electrical energy from an grid power source 10 can be used to power a multi-unit dwelling 14, which can be an apartment complex or a condominium complex, for example. The multi-unit dwelling 14 includes a first unit 14A and a second unit 14B. The first unit 14A and the second unit 14B are different residences.

In the exemplary embodiment, the grid power source 10 is owned and operated by a utility company. A plurality of power stations 18 can produce electrical energy for the grid power source 10. To produce electrical energy, the power stations 18 could include generators driven by heat engines that are fueled by burning fossil fuels, nuclear fission, flowing water, or wind. When driven, the generators produce electrical energy. In some examples, the power stations 18 could instead or additionally generate electrical energy from geothermic or solar sources.

The grid power source 10 is an interconnected network for delivering electrical energy to various locations, such as the multi-unit dwelling 14. The grid power source 10 is, in some examples, referred to as mains electricity, grid power, or wall power.

The grid power source 10 connects to the multi-unit dwelling 14 through a grid meter 22. The utility company can use the grid meter 22 to assess the amount of electrical energy provided to the multi-unit dwelling 14 from the grid power source 10.

In this example, a local renewable energy system 26 can instead or additionally provide electrical power to the multi-unit dwelling 14. The local renewable energy system 26 can generate electrical energy from a renewable source 30, (e.g., solar, wind, hydroelectric). Often, the electrical energy generated by the local renewable energy system 26 is used locally by the multi-unit dwelling 14 (i.e., without being fed to an grid power source).

That said, some local renewable energy systems 26 can connect to the grid power source 10. This enables the local renewable energy system 26 to feed electrical energy into the grid power source 10. Electrical energy generated by the local renewable energy system 26 can be fed into the grid power source 10 rather than being stored locally within a battery, for example. In exchange for the electrical energy fed into the grid power source 10, an owner of the local renewable energy system 26 may be given credits or another type of payment.

Some utility companies that manage the grid power sources have introduced programs that compensate a customer for the electrical energy fed into the grid power source 10 from a local renewable energy system 26. The compensation may be a monetary credit or another type of compensation. This exchange means that the residential or commercial customer is effectively selling electrical energy back to the utility company.

For example, a residential or commercial customer that owns the local renewable energy system 26 may receive a billing credit for electrical energy than they feed from the local renewable energy system 26 to the grid power source 10. Such compensation programs are sometimes referred to as “net metering” programs. These compensation programs provide a way to compensate an owner of a local renewable energy systems for the electrical energy added to the grid power source.

The local renewable energy system 26 is separated from the grid power source 10 by the grid meter 22, which can be considered a boundary between the grid power source 10 and the local renewable energy system 26. A person having skill in this art and the benefit of this disclosure would understand how an grid power source 10 differs from a local renewable energy system 26.

Electrical energy from the grid power source 10, the local renewable energy system 26, or both can be used to power one or more electrified vehicle charging stations 40A and 40B. Electrified vehicles 44A and 44B can each connect to one of the electrified vehicle charging stations 40A and 40B to recharge traction batteries of the electrified vehicles 44A and 44B. The traction batteries can be recharged from the grid power source 10, the local renewable energy system 26, or both.

In this example, the electrified vehicle charging stations 40A and 40B are bidirectional charging stations. The electrified vehicle charging stations 40A and 40B are thus configured to transfer electrical energy from the associated electrified vehicle 44A and 44B to the multi-unit dwelling 14. In an power outage, the utility company is unable to provide electrical energy through the electrical meter 22 to the multi-unit dwelling 14. Transferring energy from one or more of the electrified vehicles 44A and 44B to the multi-unit dwelling 14 may be required during the outage.

This disclosure relates to a local management method that monitors electrical energy provided by one or more of the electrified vehicles 44A and 44B through the electrified vehicle charging stations 40A and 40B. When an grid power source 10 is not providing electrical energy to an electrical load of the multi-unit dwelling 14, the multi-unit dwelling 14 can receive electrical energy from one or more of electrified vehicles 44A and 44B to power the electrical load of the multi-unit dwelling 14. The users of the electrified vehicles 44A and 44B can be residents of the multi-unit dwelling 14.

As can be appreciated, the multi-unit dwelling 14 can include additional units beyond units 14A and 14B. from time to time, the multi-unit dwelling 14 can have unoccupied units. Further, some residents of units in the multi-unit building 14 are not users of an electrified vehicle capable of providing bi-directional power. A parking lot associated with the multi-unit dwelling can permit parking for or demand of non-resident vehicles such as shared vehicles, shared ride vehicles, on-site maintenance vehicles, etc. which may be electrified and bi-directionally capable. Coordinating transfer of energy to the multi-unit dwelling 14 from the electrified vehicles 44A, 44B and other electrified vehicles can require coordination of multiple entities. Further, the amount of energy available from electrified vehicles used by residents of the multi-unit dwelling 14 may be lower than an demand for energy from the multi-unit dwelling 14. This can create a need to entice additional supply sources and encourage limiting use of energy from the bi-directional capable electrified vehicles that are available. Dependent on forecast availability (supply) of energy (kWh) and instantaneous power output capacity (kW) relative to forecast need (demand), compensation may also be offered to non-residents as well, such as fleets.

During a power outage, especially an extended outage, the value of power is inherently substantially higher. The users of the electrified vehicles 44A and 44B can be compensated for providing power to the electrical load of the multi-unit dwelling 14. When an outage risk is high, the users can be compensated for making their vehicle available (time parked and plugged in) for providing power to the electrical load of the multi-unit dwelling 14, where power transfer might not commence unless or until an outage begins. This step may be necessary to ensure supply commitments are secured to meet potential demand needs during a period of uncertainty.

Compensation can generally be tied to the objective of securing adequate supply, which includes maximizing efficiency of known capacity. In one embodiment, a non-bi-directional EV owner may indicate planned trips and offer (for example through mobile application) carpool rides, and an estimate of energy not consumed by the bi-directional EV valued and credited in some share to the non-bi-directional EV owner and the remaining share credited to the bi-directional EV owner, assuming the bi-directional vehicle is as a result parked and plugged in during the high risk period window.

Compensation can also be based on a time period the user makes their electrified vehicle 44A or 44B available to provide electrical energy to the multi-unit dwelling. Making one of the electrified vehicles 44A and 44B available can be accomplished by connecting that electrified vehicle to one of the electrified vehicle charging stations 40A and 40B. More availability is useful as there can be periods of high outage risk but uncertainty as to whether and when it will occur. Having electrified vehicles available and plugged in, but not charging, may be a necessary precaution to ensure that a backup system is available.

In some embodiments, especially if the high outage risk time window is longer, such as a week with extreme weather conditions and/or a stressed grid, a user of an electrified vehicle capable of transferring energy to the multi-unit dwelling 14 may receive compensation in exchange for enabling an energy saving “eco” mode for when their electrified vehicle is used, which could automatically remain on until at least the end of the high risk period window. A power management system of the multi-unit dwelling 14 could, for example, communicated the high-risk window to the electrified vehicle.

The user of the electrified vehicle 44A could reside in the first unit 14A of the multi-unit dwelling 14, and the user of the other electrified vehicle 44B could reside in the second unit 14B of the units of the multi-unit dwelling 14. If both electrified vehicles 44A and 44B powering the electrical loads of the multi-unit dwelling 14 during a grid power outage, the amount of compensation could be allocated based on the amount of electrical power provided by each of the electrified vehicles 44A and 44B.

The compensation could, in some examples, be a reduction in a rent paid by the users that occupy the multi-unit dwelling 14. The user of the electrified vehicle 44A or 44B that provides more electrical power to the multi-unit dwelling 14 during the grid outage would receive more of a reduction in their rent than the other user.

The compensation could, in other examples, be non-monetary. For example, the user of the electrified vehicle 44A or 44B that provides the most electrical energy to the multi-unit dwelling 14 could be entitled the user a particular (and desirable) parking spot near the multi-unit dwelling.

A transfer switch 48 can be transitioned when the electrified vehicles 44A and 44B are providing electrical energy to the multi-unit dwelling 14. The transitioning of the transfer switch 48 can electrically decouple the multi-unit dwelling 14 and its associated electrical loads from the grid power source 10, the local renewable energy system 26, or both.

From time-to-time, one or more of the electrified vehicles 44A and 44B could be utilized to store electrical energy generated by, for example, the local renewable energy system 26. The users of the electrified vehicles 44A and 44B can be compensated for storing the electrical energy.

Compensation can be based on variables such as how much the utility company charges the user for electrical power, the electrical power needs of the multi-unit dwelling 14, the number of electrified vehicles 44A and 44B available for providing electrical power.

In some examples, the amount of time plugged in and electrical energy that each electrified vehicle 44A or 44B contributes to the multi-unit dwelling 14 are metered by the charging stations 40A and 40B, with values transmitted to system management software. Vehicle telematics may provide supporting or validation data, such as plugged-in time and electrical energy remaining in each of the electrified vehicles 44A and 44B during a bi-directional energy transfer, during time electrified vehicles 44A and 44B are plugged in (but not necessarily transferring power) during a high risk time, and more generally at any given time to enable ongoing assessment of supply capacity. A person having skill in this art and the benefit of this disclosure could understand how to measure, monitor, or otherwise quantify an amount of electrical energy provided to the multi-unit dwelling 14 from each of the electrified vehicle 44A and 44B.

In some examples, one or more of the electrified vehicles 44A and 44B could connect to the respective charging stations 40A and 40B for grid arbitrage purposes. For example, the traction battery of the electrified vehicle 44A could be used to store electrical energy from the grid power source 10 during periods of low demand when rates are lower. During periods of high demand, electrical loads of the multi-unit dwelling 14 could be supplemented with electrical power from the traction battery of the electrified vehicle 44A. This reduces the reliance on the grid power source 10 when rates are higher.

With reference now to FIG. 2 with continuing reference to FIG. 1, the electrified vehicle 44A includes a traction battery 52 and an electric machine 56. Electrical energy from the traction battery 52 can power the electric machine 56, which then drives wheels 60 of the electrified vehicle 44A. The electrified vehicle 44B is configured similarly to the electrified vehicle 44A.

In this example, the electrified vehicle 44A is an all-electric vehicle. In other examples, the electrified vehicle 44A could be plug-in hybrid electric vehicle (PHEV), which selectively drives wheels using torque provided by an internal combustion engine instead of or in addition to, torque provided by an electric machine. Generally, the electrified vehicle 44A could be any type of vehicle having a traction battery.

In an exemplary embodiment, non-electricity energy sources such as, natural gas, propane, and hydrogen, can be stored on a vehicle. These energy sources can be transferred from the vehicle to the multi-unit dwelling 14. For example, typical compressed natural gas (CNG) powered vehicles typically store CNG fuel in tanks with a capacity of up to 3,600 PSI pressure when full, while building natural gas pressure is lower. Such a system might use hardware like a pressure regulator to ensure the right amount of pressure is fed from the vehicle into building natural gas lines, with metering of fuel transfer and compensation following methods taught in this invention.

Operating the electric machine 56 depletes an amount of electrical energy stored within the traction battery 52. The electrified vehicle 44A is configured to recharge the traction battery 52 from an external source of electrical energy, such as the charge station 40A or 40B.

The electrified vehicle 50 includes a charge port 64. The Electric Vehicle Supply Equipment (EVSE) associated with the charging station 40A or 40B can be electrically coupled to the charge port 64. When electrically coupled, the charging station 40A or 40B can supply electrical energy to the traction battery 52 to charge the traction battery 52. The traction battery 52 can be recharged with energy generated by the local renewable energy system 26, the grid power source 10, or both.

An example compensation approach could, for example, assessing that the electrified vehicle 44A, in a given month, provided 9.6 kW over 5 hours, for a total of 48 kWh in backup electrical energy to the multi-unit dwelling 14. During this event, the rate if this electrical energy was purchased from the utility company was $5.00/kWh. The backup power revenue for the month is thus $240.

In this example, a revenue for grid arbitrage provided an additional $43.30 for the month. Thus, a total revenue for these grid services is $283.30. A landlord of the multi-unit dwelling 14 could retain 10% of this amount, and the user of the electrified vehicle 44A (a resident of unit first 14A) could be awarded the remaining ninety percent or $254.88. The user may receive this compensation as a deduction in the rent paid to the landlord.

The compensation to the user of the electrified vehicle 44A could be made in other ways, such as by a direct payment, a deduction in home owner associate fees, a reduction in an electricity bill or an EV charging bill, a reduction in parking fees, or free or reduced rideshare credits

Other compensation approaches could include benefits such as extended battery warranty or service, credits/incentives/rewards to use as alternative options for transport needs when the electrified vehicle is desired to support the electrical needs of the multi-unit dwelling 14.

Other compensation approaches could include benefits such as parking spaces, priority use of the bidirectional chargers, higher share of electricity use allotted during backup power events, quantified environmental or community concerns (appeal to pro-social behavior), etc.

In some examples, an owner/manager of the multi-unit dwelling 14 could obtain additional revenue by renting out unused electrified vehicle charging stations to the public (i.e., non-residents of the multi-unit dwelling).

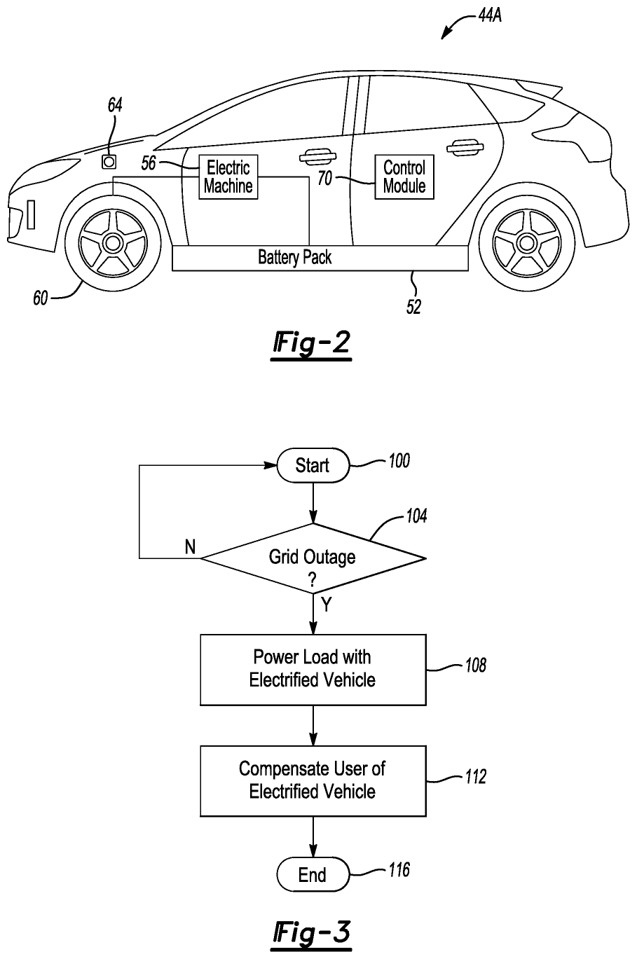

With reference to FIG. 3, a flow of an example local electrical energy management method begins at a step 100. Next, the method moves to a step 104, which assesses whether or not a grid outage is preventing powering an electrical load from an grid power source. If no, the method continues to monitor. If yes, the grid power source is unavailable to power the load, and the method moves to a step 108 where the electrical load is powered by an electrified vehicle.

Next, at a step 112, the method compensates a user of the electrified vehicle for the electrical energy that was used to power the electrical load. The compensating can be varied based on an amount of electrical energy provided by the electrified vehicle. The method then ends at a step 116.

Features of the disclosed embodiments can include an electrified vehicle charging system associated with a multi-unit dwelling. The charging system supports vehicle power transfer features like backup power and grid arbitrage. Components include: (A) Attribution of value to landlord, EV owners, and residents; (B) synchronization of storage capacity, generation capacity, and power consumption sources; and (C) encouragement of decisions that maximize electrified vehicle availability for grid services and measurement of sustainability benefits which may unlock valuable credits.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A local electrical energy management method, comprising:
when an grid power source is not providing electrical energy to an electrical load, receiving electrical energy from an electrified vehicle and powering the electrical load with the electrical energy from the electrified vehicle; and
compensating a user of the electrified vehicle for providing electrical energy.

2. The local management method of claim 1, wherein the load is a load associated with a multi-unit dwelling.

3. The local management method of claim 2, wherein the user is a resident of the multi-unit dwelling.

4. The local management method of claim 2, wherein the multi-unit dwelling is an apartment complex, a condominium complex, or both.

5. The local management method of claim 2, wherein the electrical load is an electrical load of the multi-unit dwelling.

6. The local management method of claim 1, wherein the electrical load is electrically decoupled from the grid power source during the powering.

7. The local management method of claim 1, further comprising compensating by providing a rent credit to the user.

8. The local management method of claim 1, further comprising additionally compensating the user for storing backup electrical energy within electrified vehicle.

9. The local management method of claim 1, wherein the compensating comprises a non-monetary benefit for the user.

10. The local management method of claim 1, wherein the compensating is varied based on an amount of electrical energy provided by the electrified vehicle.

11. The local management method of claim 1, wherein the electrified vehicle is a first electrified user and the user is a first user, and further comprising, when an grid power source is not providing power to an electrical load, additionally powering the load using a second electrified vehicle, and compensating a second user of the second electrified vehicle for the powering.

12. The local management method of claim 1, further comprising delivering electrical energy from the electrified vehicle to the electrical load through a bidirectional charger.

13. An electrical energy providing method, comprising:
electrically coupling an electrified vehicle to a bidirectional charger;
through the bidirectional charger, powering an electrical load of a multi-unit dwelling from the electrified vehicle; and
receiving compensation for the powering.

14. The electrical energy providing method of claim 13, wherein the powering is during a grid outage when electrical energy from a grid power source is unavailable to power the electrical load.

15. The electrical energy providing method of claim 13, wherein a user of the electrified vehicle receives the compensation, the user a resident of the multi-unit dwelling.

16. The electrical energy providing method of claim 15, wherein the compensation comprises a rent credit.

17. The electrical energy providing method of claim 15, wherein the user is a first user, wherein the electrical load includes a load associated with a first unit of the multi-unit dwelling where the first user resides, and a load associated with a different, second unit of the multi-unit dwelling where a second user resides.

18. The electrical energy providing method of claim 13, wherein the compensation receives is varied based on electrical energy provided.

19. An electrical energy providing method, comprising:
making an electrified vehicle available to provide power to a multi-unit dwelling through a bidirectional charger; and
receiving compensation for making the electrified vehicle available to provide power to the multi-unit dwelling.

20. The electrical energy providing method of claim 19, further comprising making the electrified vehicle available by electrically coupling the electrified vehicle to the bidirectional charger.
